(19) United States
(12) Patent Application Publication
(10) Pub. No.: US 2022/0250564 A1
(43) Pub. Date: Aug. 11, 2022

(54) Bumper for a Vehicle

(71) Applicant: Bayerische Motoren Werke Aktiengesellschaft, Muenchen (DE)

(72) Inventors: Oeztzan AKIF, Muenchen (DE); Michael BARTHELS, Aschheim (DE); Thorsten HAMBUSCH, Landshut (DE); Jyrki MAJAMAEKI, Dorfen (DE)

(21) Appl. No.: 17/597,208

(22) PCT Filed: Jul. 2, 2020
(86) PCT No.: PCT/EP2020/068668

§ 371 Date: Dec. 29, 2021

(30) Foreign Application Priority Data
Jul. 19, 2019 (DE) 10 2019 119 644.2

(51) Int. Cl. B60R 19/18; B60R 19/34; B60R 19/36

(52) U.S. Cl. CPC B60R 19/18; B60R 19/34; B60R 2019/186; B60R 2019/1806; B60R 19/36

(57) ABSTRACT

A bumper for a motor vehicle has at least one longitudinal beam and a transverse beam that is secured to the longitudinal beam. The transverse beam is designed as a hollow profile body and is produced by connecting, in a material fit, a plurality of straps and webs.

### BACKGROUND AND SUMMARY OF THE INVENTION

The present invention relates to a bumper for a vehicle. Furthermore, the invention relates to a vehicle comprising such a bumper. The bumper is preferably constructed in a simple and cost-effective manner.

Bumpers for motor vehicles are known from the prior art. These have in most cases a transverse beam which extends in the transverse direction of the vehicle. The transverse beam serves to absorb forces which occur in the event of the vehicle striking an obstacle in order to direct these forces to crash boxes.

Known transverse beams are in most cases produced with a shell-like construction. To this end, typically deep-drawn half-shells are assembled and welded. However, a production concept with deep-drawing tools is very cost-intensive. Furthermore, geometric applications can be carried out only in a limited manner since molding bevels always have to be provided.

An object of the invention is consequently to provide a bumper for a vehicle which enables a flexible configuration with cost-effective production and assembly.

The object is achieved by the features of the independent claim. The dependent claims contain preferred developments of the invention. The object is consequently achieved by a bumper for a vehicle which has at least one longitudinal beam and one transverse beam which is secured to the longitudinal beam. The transverse beam is constructed as a hollow profile carrier. The hollow profile member is produced by means of materially engaging connection of a large number of straps and webs. Straps and webs are known as components of profile members. In this instance, these are simple components which are generally not shaped and which can be assembled to form a hollow profile member. In this instance, there is in particular provision for each web to connect two different straps, whilst each strap is connected to at least one web, preferably to several webs.

As a result of the production of the hollow profile member from straps and webs which are connected in a materially engaging manner, it is made possible for the transverse beam to be constructed in a non-prismatic manner. Furthermore, no or only a few degrees of shaping are achieved, whereby no pre-strengthening or almost no pre-strengthening in the basic material is carried out. In particular, consequently, no deep-drawing tools are also required. Instead, the transverse beam is constructed in a simple and cost-effective manner.

As a result of the assembly of straps and webs, shapes of the transverse beam can be freely varied and adapted to given peripheral conditions. In particular, consequently, the construction of a modular bumper is enabled.

In a particularly advantageous manner, the straps and webs are produced from a metal sheet. The metal sheet is in particular a steel sheet. The straps and webs are welded to each other in order to form the hollow profile member. Consequently, simple and cost-effective production methods are provided in order to produce a bumper in a stable and reliable manner.

The transverse beam is in a particularly advantageous manner welded to the longitudinal beam. Consequently, the entire bumper, that is to say, the at least one longitudinal beam and the large number of straps and webs, is connected in a completely materially engaging manner. Consequently, the entire bumper can be handled in one piece. Furthermore, the transverse beam can be connected to the longitudinal beam in a stable and reliable manner.

Each strap and/or each web is in a particularly preferred manner a punched component. Alternatively or additionally, each strap and/or each web may be a punched/bent component. As a result of the punching operation, the shape of the straps and/or webs can be produced in a simple and cost-effective manner. If a slight shaping is required, in particular in order to adapt the transverse beam to a desired shape of the vehicle front, this can be carried out using a punching/bending method. A simple and cost-effective production of the bumper is thereby further achieved, wherein a flexible construction of the bumper, in particular the transverse beam, is enabled.

In a particularly preferred manner, the straps have slots. In contrast, the webs preferably have projections. The webs can thereby be inserted into the straps in order to thus shape the bumper, in particular the hollow profile member. In a subsequent production step, by means of materially engaging connection, in particular by welding, the final transverse beam can be produced from the straps and webs. As a result of the slots and projections, consequently, a simple and non-complex assembly of the transverse beam is achieved. The slots and projections can be produced in a particularly advantageous manner with the punching method or punching/bending method described above.

Each longitudinal beam preferably has an overhang. The overhang engages in a recess of at least one of the straps. A secure and reliable connection of the longitudinal beam and transverse beam is thereby achieved. The bumper is thereby constructed in a stable manner.

In a particularly advantageous manner, the transverse beam is secured to two longitudinal beams. The longitudinal beams are particularly constructed as crash boxes. In a particularly advantageous manner, the longitudinal beams are arranged symmetrically on the transverse beam, whereby the axis of symmetry advantageously coincides with a longitudinal axis of the vehicle when the bumper is arranged on a vehicle. It is thereby possible for a force which acts on the transverse beam in the event of a crash to be able to be transmitted to the crash boxes in a safe and reliable manner in order to thus absorb crash energy of the vehicle.

A width of the webs is advantageously at a maximum at a middle position between the longitudinal beams. The middle position corresponds in particular to the position of the axis of symmetry, that is to say, in particular also to the position of the center axis of the vehicle. The width of the webs is a dimension which corresponds to the spacing of the straps which are connected by means of the webs. This width of the webs advantageously decreases in the direction toward each longitudinal beam. It is thereby in particular possible for a minimum width of the webs to be provided directly at the longitudinal beams, which width increases, in particular continuously, in the direction toward the middle position. Consequently, at the middle position, that is to say, at the center axis of the vehicle, the maximum width of the webs is achieved. This maximum width is preferably a maximum of 100 mm. In a particularly preferred manner, this maximum width is a maximum of 80 mm. As a result of such a configuration, a space-saving construction of the bumper is achieved.

A thickness of the straps and/or webs is preferably between 3 mm and 5 mm. In a particularly advantageous manner, the thickness is 4 mm. The thickness consequently preferably corresponds to the thickness of the metal sheets which are used as straps and/or webs. As a result of such a construction, an optimum behavior of the bumper with minimized weight can be achieved.

The invention further relates to a vehicle. The vehicle has a bumper as described above. In particular, the bumper is fitted to a vehicle front and/or to a vehicle rear. As a result of the bumper, crash energy of the vehicle can be absorbed. Generally, the bumper can be coated with plastics material coatings.

Other details, features and advantages of the invention will be appreciated from the following description and the figures.

### BRIEF DESCRIPTION OF THE DRAWINGS

FIG. 1 is a schematic illustration of a vehicle according to an embodiment of the invention; and

FIG. 2 is a schematic exploded illustration of a bumper of the vehicle according to the embodiment of the invention.

### DETAILED DESCRIPTION OF THE DRAWINGS

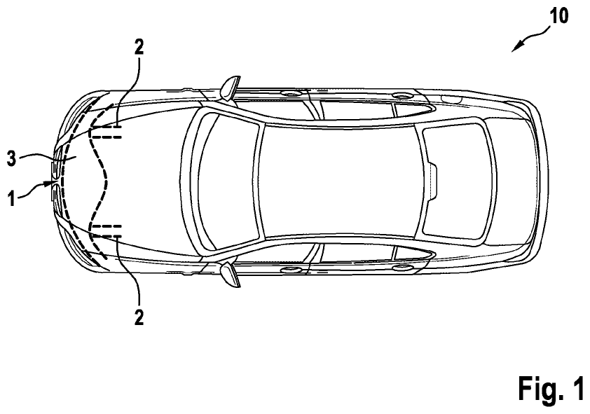

FIG. 1 is a schematic illustration of a vehicle 10 according to an embodiment of the invention. The vehicle 10 has at the vehicle front thereof a bumper 1 which in turn comprises two longitudinal beams 2 and a transverse beam 3. The bumper 1 is particularly constructed symmetrically relative to a longitudinal vehicle axis.

If the vehicle strikes an obstacle with its front, the forces from the cross member 3 can be introduced into the longitudinal beams 2. The longitudinal beams 2 are preferably constructed as crash boxes for receiving the crash energy.

As is the case with the vehicle front, the bumper 1 may also be fitted to the vehicle rear in order to also absorb crash energy at this location.

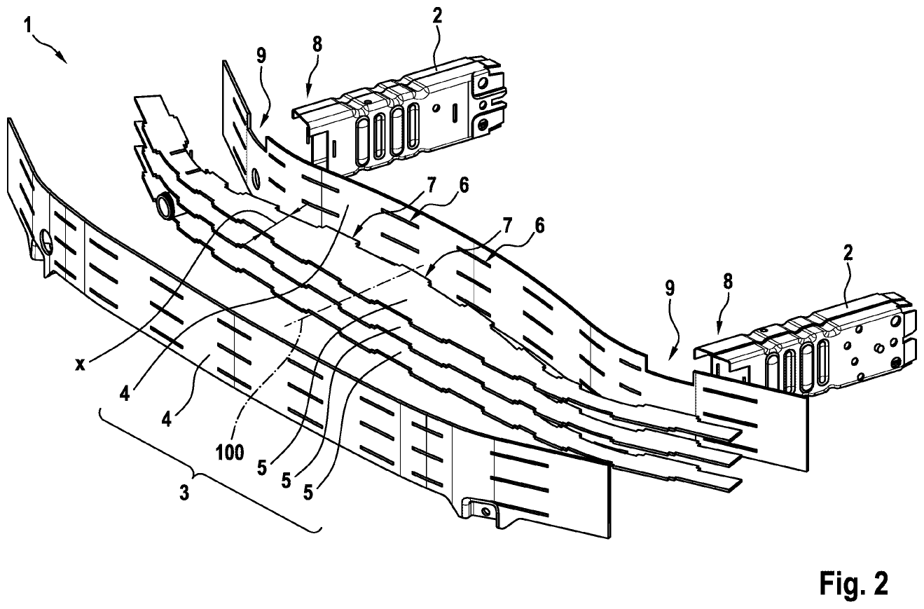

FIG. 2 is a schematic exploded illustration of the bumper 1 of the vehicle 10 according to the embodiment of the invention. In this instance, the transverse beam 3 is formed as a combination of a large number of straps 4 and webs 5. By connecting the straps 4 and the webs 5 in a materially engaging manner, the transverse beam 3 is constructed as a hollow profile member. The individual components of the hollow profile member, that is to say, the straps 4 and the webs 5, are in this instance simple and almost non-shaped initial elements, in particular steel sheets. These elements can be assembled and welded to form the hollow profile member in order to consequently obtain a stable transverse beam 3.

In order to simplify the construction of the transverse beam 3 from the straps 4 and webs 5, the straps 4 have slots 6. Projections 7 of the webs 5 can be introduced into the slots 6. Consequently, the entire transverse beam 3 can be assembled in advance, whereby a subsequent welding of the belts 4 and webs 5 is simplified.

The straps 4 and webs 5 are particularly produced as punched components or punched/bent components. In particular, the slots 6 and the projections 7 can thereby be produced in a simple and non-complex manner. The shaping of the straps 4 and the webs 5 can also be configured in a variable manner. A flexible method for configuration of the transverse beam 3 is thereby achieved.

In particular, a spacing between the straps 4 is not constant, but instead changes in the transverse direction of the vehicle. There is thus provision for the spacing between the straps 4 to be largest at a middle position 100 between the two longitudinal beams 2. A web width x of the webs 5 at this position is thereby at a maximum. In particular, the web width x is a maximum of 100 mm, in a particularly advantageous manner a maximum of 80 mm. In the direction toward the longitudinal beams 2, the spacing between the straps 4 and consequently the web width x of the webs 5 decreases. On the longitudinal beams 2, particularly a minimum web width x is consequently provided. As a result of such a variable configuration of the web width x, consequently, an optimal bumper 1 which in particular has a minimized weight can be constructed.

The connection of the transverse beam 3 to the longitudinal beams 2 is also in particular carried out by means of welding. To this end, the transverse beam 3 has on at least one strap 4 a recess 9 for each longitudinal beam 2. An overhang 8 of the longitudinal beam 2 engages in the recess 9. By subsequently welding the strap 4 and longitudinal beam 2, an optimum and stable connection between the transverse beam 3 and longitudinal beams 2 can be achieved.

The straps 4 and webs 5 are in a particularly advantageous manner steel sheets. A material thickness of the steel sheets is in this instance preferably between 3 mm and 5 mm. In a particularly preferred manner, the thickness is 4 mm.

The bumper described is consequently constructed in a simple and cost-effective manner. At the same time, a flexible shaping can be achieved. Finally, the bumper 1 is constructed in a stable manner.

### LIST OF REFERENCE NUMERALS

1 Bumper
2 Longitudinal beam
3 Transverse beam
4 Strap
5 Web
6 Slot
7 Projection
8 Overhang
9 Recess
10 Vehicle
100 Middle position

1.-10. (canceled)

11. A bumper for a vehicle, comprising:
at least one longitudinal beam; and
one transverse beam which is secured to the longitudinal beam, wherein the transverse beam is constructed as a hollow profile member configured with materially engaging connections of a large number of straps and webs.

12. The bumper according to claim 11, wherein
the straps and webs are configured from a metal sheet and welded to each other.

13. The bumper according to claim 12, wherein
the transverse beam is welded to the longitudinal beam.

14. The bumper according to claim 11, wherein
each strap and/or web is a punched component or a punched/bent component.

15. The bumper according to claim 11, wherein
the straps have slots into which projections of the webs are inserted.

16. The bumper according to claim 11, wherein
each longitudinal beam has an overhang which engages in a recess of at least one of the straps.

17. The bumper according to claim 11, wherein
the transverse beam is secured to two longitudinal beams, wherein the two longitudinal beams are constructed as crash boxes.

18. The bumper according to claim 17, wherein
a web width of the webs which corresponds to a spacing of the straps connected by the webs is at a maximum at a middle position between the longitudinal beams and decreases in the direction toward each longitudinal beam, and
the web width at the center is a maximum of 100 mm.

19. The bumper according to claim 18, wherein
the web width at the center is a maximum 80 mm.

20. The bumper according to claim 18, wherein
a thickness of the straps and/or webs is between 3 mm and 5 mm.

21. The bumper according to claim 20, wherein
a thickness of the straps and/or webs is 4 mm.

22. The bumper according to claim 11, wherein
a thickness of the straps and/or webs is between 3 mm and 5 mm.

23. A vehicle comprising a bumper according to claim 11.

24. A method for producing a bumper for a motor vehicle, comprising:
providing at least one longitudinal beam of a vehicle;
configuring a transverse beam by connecting a plurality of straps and webs in a materially engaging manner to form a hollow profile member; and
securing the transverse beam to the longitudinal beam.

25. The method according to claim 24, wherein
the straps and webs are configured from a metal sheet and welded to each other.

26. The method according to claim 25, wherein the transverse beam is welded to the longitudinal beam.

27. The method according to claim 24, wherein
each strap and/or web is a punched component or a punched/bent component.

28. The method according to claim 24, wherein
the straps have slots into which projections of the webs are inserted.

29. The method according to claim 24, wherein
each longitudinal beam has an overhang which engages in a recess of at least one of the straps.

30. The method according to claim 24, wherein
the transverse beam is secured to two longitudinal beams, wherein the longitudinal beams are constructed as crash boxes.
